(19) United States
(12) Patent Application Publication
(10) Pub. No.: US 2007/0063657 A1
(43) Pub. Date: Mar. 22, 2007

(54) Light string and method of assembling thereof

(76) Inventor: Qingbiao Wu, Fujian (CN)

Correspondence Address: PERKINS COIE LLP, POST OFFICE BOX 1208, SEATTLE, WA, 98111-1208, US

(21) Appl. No.: 11/332,791

(22) Filed: Jan. 12, 2006

(30) Foreign Application Priority Data
Sep. 16, 2005 (CN) 200520075676.3
Sep. 16, 2005 (CN) 200520075681.4

(51) Int. Cl. H05B 37/00

(52) U.S. Cl. 315/205

(57) ABSTRACT

The embodiments of the present invention allow every light string to connect multiple LED blocks, wherein each block has a bridge rectifier circuit to supply the power. For connecting many LEDs to a light string, the LEDs can be divided into multiple blocks that is best adapted to the situation with relatively low AC voltage. Moreover, every two of the adjoining bridge rectifier circuits share two rectifying diodes in common.

### CROSS-REFERENCE TO RELATED APPLICATIONS

The present application claims priority to Chinese Patent Application No. 200520075676.3, filed Sep. 16, 2005, and Chinese Patent Application No. 200520075681.4, filed Sep. 16, 2005, the disclosures of both of which are incorporated by reference herein in their entirety, including drawings.

### FIELD OF THE INVENTION

The present invention relates to a kind of light string, particularly to a light string employing light emitting diode as the lighting source.

### BACKGROUND OF THE INVENTION

Patent No. 03273878.1 entitled “A Decorative Light Lamp” whose schematic diagram as shown on FIG. 1 describes a light string comprising a rectification circuit and a light string, wherein the rectification circuit employs bridge rectifier to form a connection with the Alternating Current (AC) source, and the light string of 10-50 Light Emitting Diodes (LEDs) are coupled upon the load loop of the rectification circuit. Constraint by the bridge rectifier power limit and the AC voltage, this kind of light string can only connect a limited number of LEDs.

When used in its common application, a power source is used to supply power to a plurality of light strings whose working method, as shown on FIG. 2, includes connecting the wires associated the output terminals of the bridge rectifier and the negative terminal of the last LED of the last light string to an electrical outlet, next light string is powered through an associated electrical outlet having a connection with this electrical outlet. However, the number of light strings to be connected is strictly confined as a result of the power limit in the bridge rectifier.

Another kind of working method, as shown on FIG. 3, is by connecting the wires associated the input terminals of the bridge rectifier to an electrical outlet so to supply power to a light string, next light string is powered in the same way. Its attached electrical outlet is plugged into said electrical outlet to get the current; the current then flowing through the associated bridge rectifier and lightening the next light string. This kind of light string is free from the power constraint of the bridge rectifier, but increase the requirement for additional wires that can lead the current to flow from one light string to the others. The additional wires means additional cost to the production since the price of wire is relatively high.

A wire-saving method employs four rectifying diodes in a bridge arrangement to achieve a bridge rectifier circuit as shown on FIG. 4, in where the output loop is formed intermediate the intersection of the negative terminals of two of the rectifying diodes and the intersection of the positive terminals of another two, every LED is coupled with the polarity oriented in the same direction along the output loop of the bridge rectifier circuit.

A plurality of light strings can be connected in parallel form along the output loop of the bridge rectifier circuit as shown on FIG. 5, which makes use of a separate bridge rectifier circuit to rectify the alternating current before supplying to every light string. Such kind of light string is free from the power limit of the bridge circuit and can be connected as many as possible. When multiple light strings are connected, every light string, disregard the pair of wires for conducting the alternating current, uses only a lead wire for coupling the LEDs on the output loop of the bridge circuit. However, this kind of light string can only connect a limited number of LEDs that when exceed, will cause voltage step-down and LED malfunction in the end. Moreover, when multiple blocks are connected in parallel form, the current flowing to every block is too small to power every LED due to the current divide. In addition, every light string needs a bridge rectifier circuit of four rectifying diodes to maintain a normal operation when multiple of them are connected together. This will add additional cost to the production.

Another wire-saving method, as shown on FIG. 6, employs double half-wave rectification circuit and a LED series block with its positive terminal connecting to the output terminals of the double half-wave rectification circuit, whereas its negative terminal is connected to the terminals of the AC source through a respective resistor. Thus, the LED series block and the resistors in the double half-wave rectification circuit receive a pair of double half-wave rectifying voltage, respectively. When multiple of this kind of light strings are connected, every light string, disregard the pair of wires for conducting the alternating current, uses only a lead wire for coupling the LEDs on the output loop of the bridge circuit. Apparently, the production cost is reduced thereof, but this circuitry has a major drawback, that is, two resistors and a AC source has formed a current loop. Heat conversion and the power consumption are relatively high in this case. Moreover, when connecting with multiple LEDs, the light string often runs out of order because of sudden voltage step-down.

### SUMMARY OF THE INVENTION

It is the object of the present invention to provide a kind of light string that is able to connect multiple LEDs with a low cost scheme.

It is another object of the present invention to provide an improved light string that can connect a plurality of LEDs with less power consumption.

In accordance with one embodiment of the present invention, there is provided an improved LED light string comprising at least one set of double half-wave rectification circuit and at least one LED series block with its positive terminal connecting to the terminals of said double half-wave rectification circuit; an impedance device is coupled intermediate the positive terminal of each of the rectifying diodes in said double half-wave rectification circuit and the AC source, and a pair of diodes of the same polarity is coupled intermediate the negative terminal of each of said LED series block and the AC source terminals. Each of said double half-wave rectification circuit is connected with one said series block at the corresponding output terminals. Each of said double half-wave rectification circuit is connected with a pair of said series blocks at the corresponding output terminals. The positive terminal of each of said diodes is connected respectively to the negative terminal of each of said LED series block(s), whereas the negative terminal of each of said diodes is connected to the terminals of the AC source through a respective resistor.

A plurality of said double half wave rectification circuits can be connected, in where the negative terminal of the LED series block in the next two sets of double half-wave rectification circuit is connected with the negative terminal of the LED series block in the last two sets of double half-wave rectification circuit, and two diodes of the same polarity are coupled intermediate the negative terminal of another set of LED series block in said next two sets of double half-wave rectification circuit and the terminals of the AC source.

The output terminal of said AC source is connected to an electrical outlet through the attached lead wire, whereas the electrical outlet refers to the electric socket.

When putting the present invention into operation, each of the half waves uses a resistor to reduce the voltage and impede the flow of the current, thus receiving the advantages of heat reduction, energy saving and cost deduction. Moreover, every LED block has four resistors connecting to the terminals of the AC source with the arrangement of two at the top and two at the bottom. Such arrangement forms a compact structure with a small volume that leads to a further deduction in cost. In addition, every light string of the present invention may contain a plurality of double half-wave rectification circuits that in return, guarantee the supply of voltage and current for every LED coupled in the series block, especially when the light string has multiple LED series blocks. Comparing with the existing methods, the present invention has the characteristics of low cost, low power consumption and capable of connecting a large number of LEDs.

In accordance with another embodiment of the present invention, there is provided a light string comprising a bridge rectifier circuit of four rectifying diodes connected in a bridge arrangement and a LED series block coupled upon the output loop of said bridge rectifier circuit, wherein said bridge rectifier circuit and said LED series block are at least two in number. A bridge rectifier circuit is formed combing the two rectifying diodes of the next bridge rectifier circuit having a connection at the negative polarity or the two rectifying diodes of the next bridge rectifier circuit having a connection at the positive polarity, with the two rectifying diodes of the last bridge rectifier circuit having a connection at the positive polarity or the two rectifying diodes of the last bridge rectifier circuit having a connection at the negative polarity; the LED series block of the two adjacent said bridge rectifier circuit is coupled with the LEDs of opposite polarity.

The bridge rectifier circuit next to the AC source has two rectifying diodes interlinked at the positive terminals; the two rectifying diodes of said bridge rectifier circuit having a connection at the negative terminal associated with the two rectifying diodes of the next bridge rectifier circuit having a connection at the positive terminal have formed a bridge rectifier circuit.

The bridge rectifier circuit next to the AC source has two rectifying diodes interlinked at the negative terminals; the two rectifying diodes of said bridge rectifier circuit having a connection at the negative terminal associated with the two rectifying diodes of the next bridge rectifier circuit having a connection at the positive terminal have formed a bridge rectifier circuit. The two output terminals of said AC source are connected to an electrical outlet through the attached wire, respectively, whereas the electrical outlet refers to the electric socket. A resistor is coupled at the two end of each of said LED series blocks, respectively.

The embodiments of the present invention allows a light string to connect multiple series blocks. Each block has a bridge rectifier circuit to supply the power. For connecting many LEDs to a light string, the LEDs can be divided into multiple blocks that, is best adapted to the situation with relatively low AC voltage. Moreover, every two of the adjoining bridge rectifier circuits share two rectifying diodes in common.

### BRIEF DESCRIPTION OF THE DRAWINGS

FIG. 1 shows the schematic diagram of circuit 1.

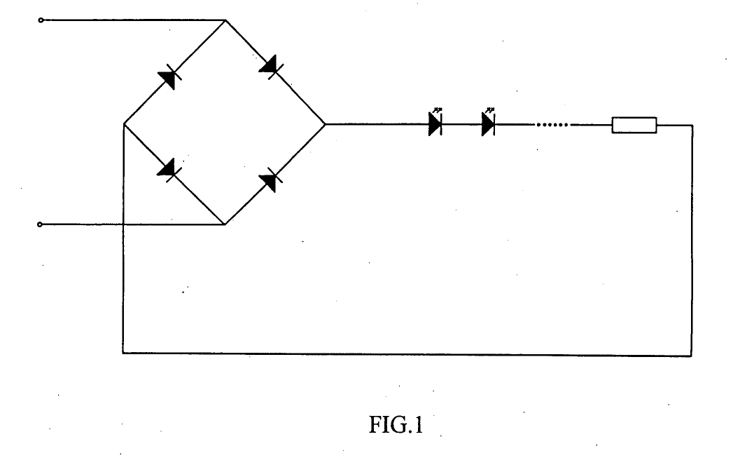

FIG. 2 shows the schematic diagram of circuit 2.

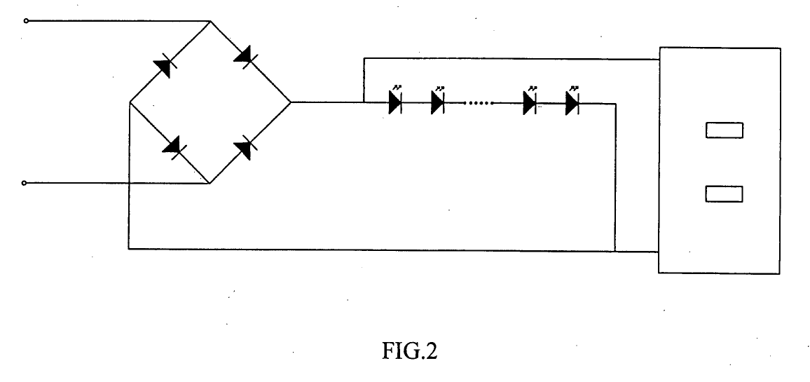

FIG. 3 shows the schematic diagram of circuit 3.

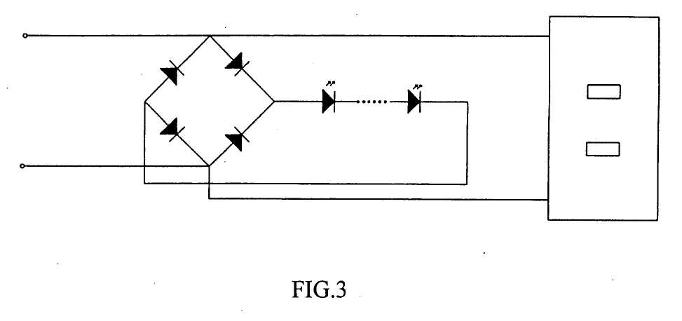

FIG. 4 shows the schematic diagram of circuit 4.

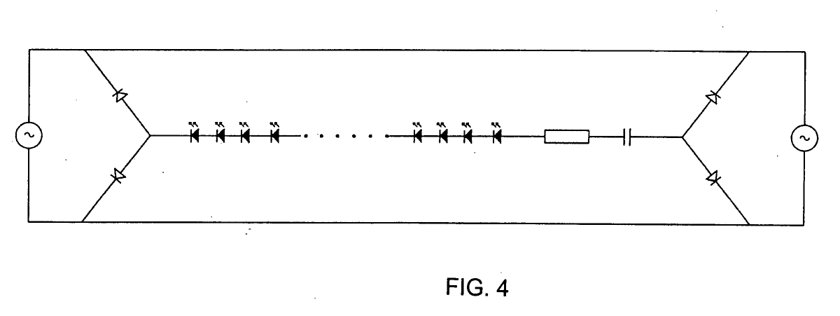

FIG. 5 shows the schematic diagram of circuit 5.

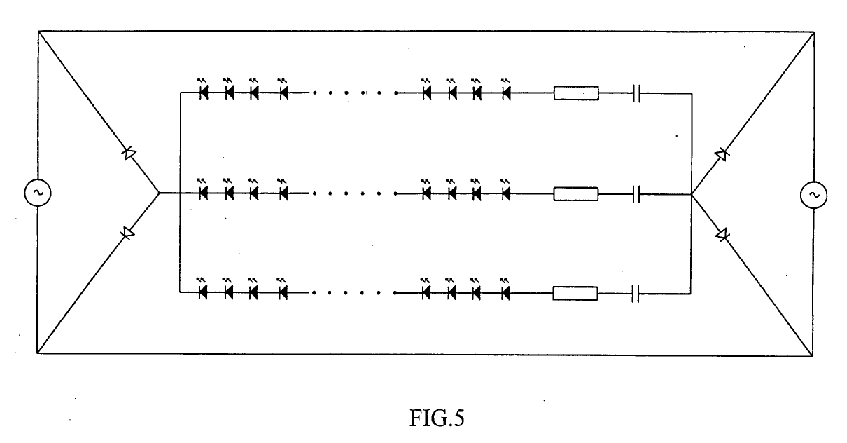

FIG. 6 shows the schematic diagram of circuit 6.

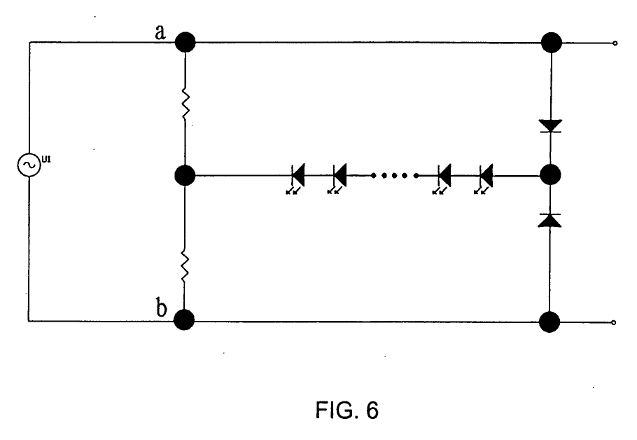

FIG. 7 shows the schematic diagram of an embodiment of the present invention.

FIG. 8 shows the schematic diagram of another embodiment of the present invention.

FIG. 9 shows the schematic diagram of another embodiment of the present invention.

FIG. 10 shows the schematic diagram of another embodiment of the present invention.

FIG. 11 shows the schematic diagram of another embodiment of the present invention.

### DETAILED DESCRIPTION OF THE INVENTION

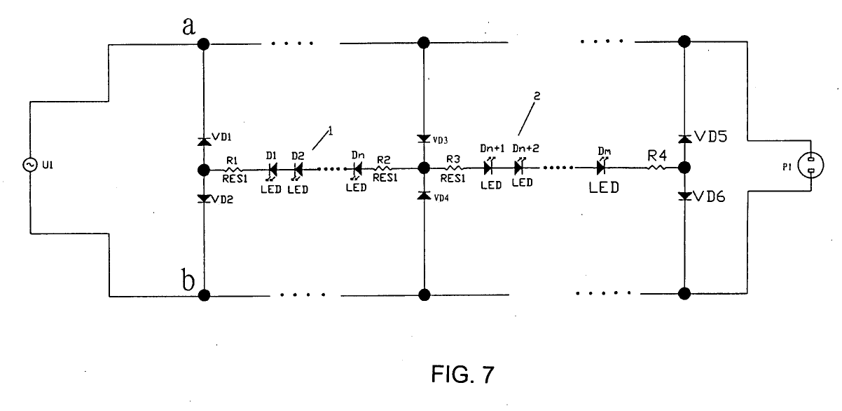

Referring to FIG. 7, the enbodiment includes rectifying diodes VD1, VD2, VD3, VD4, VD5, VD6, resistors R1, R2, R3, R4, series block1 of multiple LEDs D1-Dn that are connected with the same polarity, series block 2 of multiple LEDs Dn+1-Dm that are connected with the same polarity, and electric socket P1. The AC source is connected to the negative terminal of the rectifying diode VD1, to the positive terminal of the rectifying diode VD3 and to the negative terminal of the rectifying diode VD5 at one terminal, and connected to the negative terminal of the rectifying diode VD2, to the positive terminal of the rectifying diode VD4 and to the negative terminal of the rectifying diode VD6 at another terminal. Resistor R1 is connected to the positive terminal of both rectifying diodes VD1 and VD2 at one terminal, and connected to the negative terminal of the LED D1 at another terminal. Resistor R2 and R3 are connected to both the rectifying diodes VD3 and VD4 at one terminal; resistor R2 is connected to the positive terminal of the LED Dn at another terminal, and resistor R3 is connected to the positive terminal of the LED Dn+1 at another terminal; Resistor R4 is connected to the positive terminals of rectifying diodes VD5 and VD6 at one terminal, and connected to the negative terminal of the LED Dm at another terminal. The terminals of the AC source are connected respectively to the two input terminals of the electric socket P1, respectively.

As shown in FIG. 7, the AC output is positive at terminal a and negative at terminal b during first positive half cycle. At this time, only rectifying diodes VD3, VD2, VD6 are conducting; current flowing from the terminal a has passed through rectifying diode VD3, resistor R2, series block 1, resistor R1, rectifying diode VD2 and formed a loop with terminal b thereof, giving series block 1 a half-wave rectifying voltage; simultaneously, the current flowing from terminal a has passed through rectifying diode VD3, resistor R3, series block 2, resistor R4, rectifying diode VD6 and formed another loop with terminal b thereof, giving series block 2 a half-wave rectifying voltage. During the next half cycle, the AC polarity reverses. AC output is negative at terminal a and positive at terminal b. Now, only rectifying diodes VD4, VD1, VD5 carry current while rectifying diode VD3, VD2, VD6 formerly carrying current during the last half-cycle sit idle. Current flowing from terminal b has passed through rectifying diode VD4, resistor R2, series block 1, resistor 1, rectifying diode VD1 and formed a loop with terminal a thereof, giving series block 1 another half-wave rectifying voltage; at the same time, current flowing from terminal b has passed through rectifying diode VD4, resistor R3, series block 2, resistor R4, rectifying VD5 and form a loop with terminal a thereof, giving series block 2 another half-wave rectifying voltage. Repetition of such process in the circuitry provides the series block 1, 2 with a double half-wave rectifying voltage that can effectively prevent the LEDs from blinking and thus, elongate its lifespan.

Also shown in FIG. 7, rectifying diodes VD1, VD2, VD3, VD 4 are arranged in a bridge circuit, whereas rectifying diodes VD3, VD4, VD5, V6 formed another bridge rectifier circuit. LEDs are divided into two series blocks, each has a bridge rectifier circuit to supply the power and shares two rectifying diodes with one another.

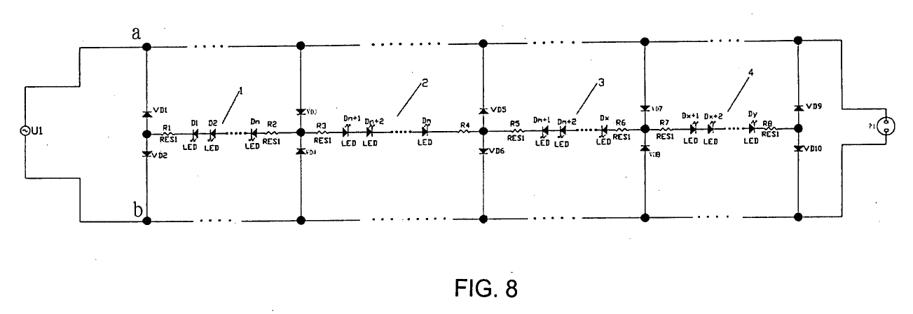

The embodiment as shown on FIG. 8 includes rectifying diodes VD1, VD2, VD3, VD4, VD5, VD6, VD7, VD8, VD9, VD10, resistors R1, R2, R3, R4, R5, R6, R7, R8, four series blocks1, 2, 3, 4 of multiple LEDs D1-Dn, LED Dn+1-Dm, LED Dm+1-Dx, LED Dx+1-Dy that are connected with the same polarity, and electric socket P1. The AC source is connected to the negative terminal of the rectifying diode VD1, to the positive terminal of the rectifying diode VD3, to the negative terminal of the rectifying diode VD5, to the positive terminal of the rectifying diode VD7 and the negative terminal of the rectifying diode VD9 at one terminal, and connected to the negative terminal of the rectifying diode VD2, to the positive terminal of the rectifying diode VD4, to the negative terminal of the rectifying diode VD6, to the negative terminal of the rectifying diode VD8 and to the negative terminal of the rectifying diode VD10 at another terminal. Resistor R1 is connected to the positive terminal of the rectifying diodes VD1 and VD2 at one terminal, and connected to the negative terminal of the LED D1 at another terminal. Resistor R2 and R3 are respectively connected to the rectifying diodes VD3 and VD4 at one terminal; resistor R2 is connected to the positive terminal of the LED Dn at another terminal, and resistor R3 is connected to the positive terminal of the LED Dn+1 at another terminal; resistor R4, R5 are respectively connected to the positive terminals of the rectifying diodes VD5 and VD6 at one terminal, resistor R4 is connected to the negative terminal of the LED Dm at another terminal, and resistor R5 is connected to the negative terminal of the LED Dm+1 at another terminal; resistor R6, R7 are respectively connected to the positive terminals of the rectifying diodes VD7 and VD8 at one terminal, resistor R6 is connected to the negative terminal of the LED Dx at another terminal, and resistor R7 is connected to the positive terminal of the LED Dx+1 at another terminal; Resistor R8 is connected to the negative terminal of LED Dy at one terminal, and connected to the rectifying diodes VD9, VD10 at another terminal.

When putting the second embodiment into work, the AC output is positive at terminal a and negative at terminal b during first positive half cycle. At this time, only rectifying diodes VD2, VD3, VD6, VD7, VD10 are conducting; current flowing from the terminal a has passed through rectifying diode VD3, resistor R2, series block 1, resistor R1, rectifying diode VD2 and formed a loop with terminal b thereof, giving series block 1 a half-wave rectifying voltage; simultaneously, the current flowing from terminal a has passed through rectifying diode VD3, resistor R3, series block 2, resistor R4, rectifying diode VD6 and formed another loop with terminal b thereof, giving series block 2 a half-wave rectifying voltage; at the same time, the current flowing from terminal a has passed through rectifying diode VD7, resistor R6, series block 3, resistor R5, rectifying diode VD6 and formed another loop with terminal b thereof, giving series block 3 a half-wave rectifying voltage; simultaneously, the current flowing from terminal a has passed through rectifying diode VD7, resistor R7, series block 4, resistor R8, rectifying diode VD10 and formed another loop with terminal b thereof, giving series block 4 a half-wave rectifying voltage. During the next half cycle, the AC polarity reverses. AC output is negative at terminal a and positive at terminal b. Now, only rectifying diodes VD1, VD4, VD5, VD8, VD9 carry current while rectifying diode VD2, VD3, VD6, VD7, VD10 formerly carrying current during the last half-cycle sit idle. Current flowing from terminal b has passed through rectifying diode VD4, resistor R2, series block 1, resistor 1, rectifying diode VD1 and formed a loop with terminal a thereof, giving series block 1 another half-wave rectifying voltage; simultaneously, current flowing from terminal b has passed through rectifying diode VD4, resistor R3, series block 2, resistor R4, rectifying VD5 and form a loop with terminal a thereof, giving series block 2 another half-wave rectifying voltage; at the same time, current flowing from terminal b has passed through rectifying diode VD8, resistor R6, series block 3, resistor R5, rectifying VD5 and formed a loop with terminal a thereof, giving series block 3 another half-wave rectifying voltage; simultaneously, current flowing from terminal b has passed through rectifying diode VD8, resistor R7, series block 4, resistor R8, rectifying VD9 and formed a loop with terminal a thereof, giving series block 4 another half-wave rectifying voltage. Repetition of such process in the circuitry provides the series block 1, 2, 3, 4 with a respective double half-wave rectifying voltage.

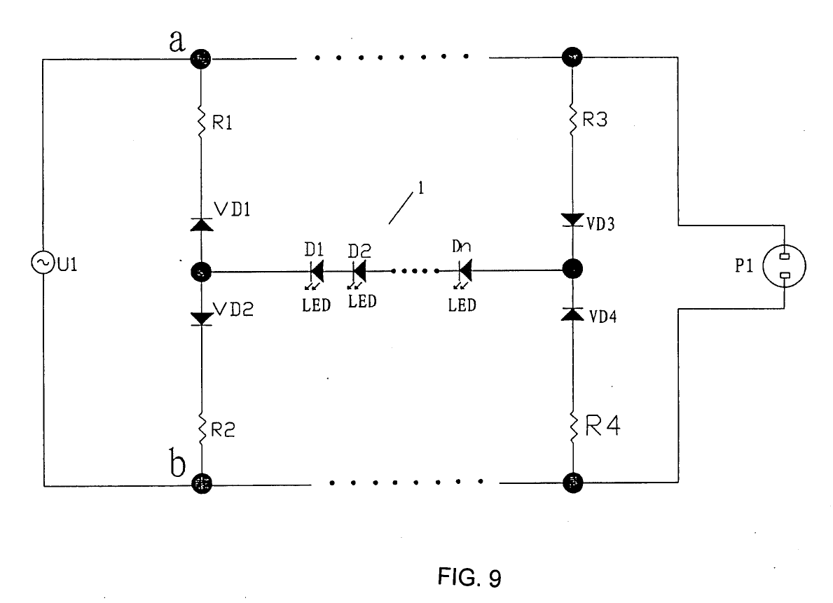

As shown on FIG. 9, another embodiment of the present invention includes diodes VD1, VD2, rectifying diodes VD3, VD4, resistors R1, R2, R3, R4, an electric socket P1, and a series block 1 of 50 LEDs D1-Dn that are connected with the same polarity. Resistors R1, R3 are connected with the terminal of AC source at one terminal, and connected respectively with the negative terminal of diode VD1 and the positive terminal of rectifying diode VD3 at another terminal; resistor R2, R4 are connected to another terminal of the AC source at one end, and connected respectively with the negative terminal of diode VD2 and the positive terminal of rectifying diode VD4 at another end; the positive terminal of diodes VD1, VD2 are connected to the negative terminal of the LED D1, and the negative terminal of rectifying diodes VD3, VD4 are connected to the positive terminal of the LED Dn. The terminals of the AC source are connected respectively to the two input terminals of the electric socket P1.

As shown in FIG. 9, when power is on, the AC output is positive at terminal a and negative at terminal b during first positive half cycle. At this time, only rectifying diode VD3 and diode VD2 are conducting; current flowing from the terminal a has passed through resistor R3, rectifying diode VD3, LEDs D1-Dn, diode VD2, resistor R2 and formed a loop with terminal b thereof, giving LEDs D1-Dn a half-wave rectifying voltage. During the next half cycle, the AC polarity reverses. AC output is negative at terminal a and positive at terminal b. Now, only rectifying diode VD4 and diode VD1 carry current while rectifying diode VD3 and diode VD2 formerly carrying current during the last half-cycle sit idle. Current flowing from terminal b has passed through resistor R4, rectifying diode VD4, LEDs D1-Dn, diode VD1, resistor R1 and formed a loop with terminal a thereof, giving LEDs D1-Dn another half-wave rectifying voltage. Repetition of such process in the circuitry provides the series block 1 with a double half-wave rectifying voltage that can effectively prevent LEDs D1-Dn from blinking and thus, elongate its lifespan.

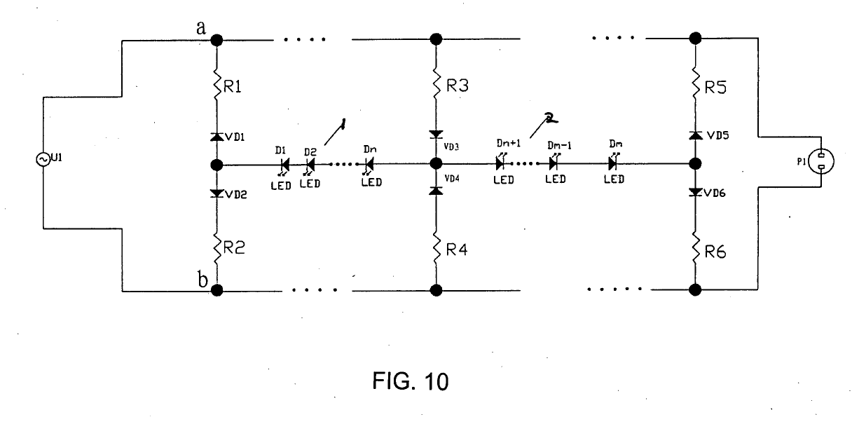

As shown in FIG. 10, another embodiment of the present invention includes diodes VD1, VD2, VD5, VD6, rectifying diodes VD3, VD4, resistors R1, R2, R3, R4, R5, R6, an electric socket P1, and two series blocks 1, 2, each comprising 50 LEDs D1-Dn, LEDs Dn+1-Dm that are connected with the same polarity. Resistors R1, R3, R5 are connected to the terminal of the AC source at one terminal, and connected respectively with the negative terminal of diode VD1, the positive terminal of rectifying diode VD3 and the negative terminal of diode VD5 at another terminal; resistor R2, R4 R6 are connected to the other terminal of the AC source at one end, and connected respectively with the negative terminal of diode VD2, the positive terminal of rectifying diode VD4 and negative terminal of diode VD6 at another end; the positive terminal of diodes VD1, VD2 are connected to the negative terminal of the LED D1, and the negative terminal of rectifying diodes VD3, VD4 are connected to the positive terminal of the LED Dn and the positive terminal of the LED Dn+1; the positive terminal of diodes VD5, VD6 are connected to the negative terminal of the LED Dm. The terminals of the AC source are connected respectively to the two input terminals of the electric socket P1.

As shown in FIG. 10, when power is on, the AC output is positive at terminal a and negative at terminal b during first positive half cycle. At this time, only rectifying diode VD3, diode VD2 and diode VD6 are conducting; current flowing from the terminal a has passed through resistor R3, rectifying diode VD3, LEDs D1-Dn, diode VD2, resistor R2 and formed a loop with terminal b thereof, giving LEDs D1-Dn a half-wave rectifying voltage. Simultaneously, current flowing from the terminal a has passed through resistor R3, rectifying diode VD3, LEDs Dn+1-Dm, diode VD6, resistor R6 and formed a loop with terminal b thereof, giving LEDs Dn+1-Dm a half-wave rectifying voltage. During the next half cycle, the AC polarity reverses. AC output is negative at terminal a and positive at terminal b. Now, only rectifying diode VD4, diode VD1 and diode VD5 carry current while rectifying diode VD3, diode VD2 and diode VD6 formerly carrying current during the last half-cycle sit idle. Current flowing from terminal b has passed through resistor R4, rectifying diode VD4, LEDs D1-Dn, diode VD1, resistor R1 and formed a loop with terminal a thereof, giving LEDs D1-Dn another half-wave rectifying voltage. At the same time, current flowing from terminal b has also passed through resistor R4, rectifying diode VD4, LEDs Dn+1-Dm, diode VD5, resistor R5 and formed a loop with terminal a thereof, giving LEDs Dn+1-Dm another half-wave rectifying voltage. Repetition of such process in the circuitry provides the series blocks 1, 2 with a double half-wave rectifying voltage, respectively.

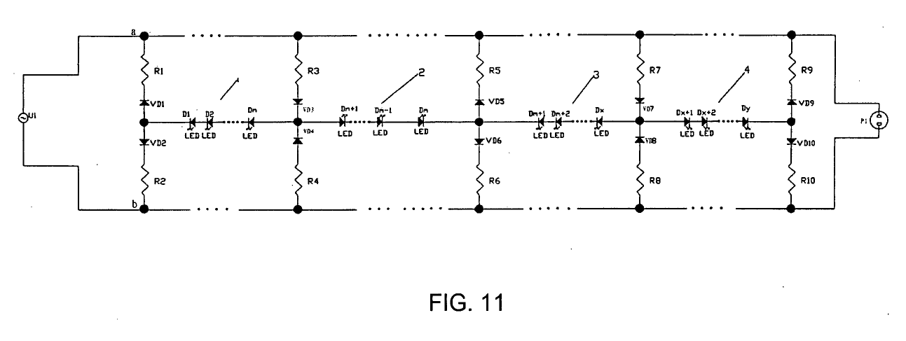

As shown in FIG. 11, another embodiment of the present invention includes diodes VD1, VD2, VD5, VD6, VD9, VD10, rectifying diodes VD3, VD4, VD7, VD8, resistors R1, R2, R3, R4, R5, R6, R7, R8, R9, R10, an electric socket P1, and four series blocks 1, 2, 3, 4 of 50 LEDs D1-Dn, Dn+1-Dm, Dm+1-Dx, Dx+1-Dy that are connected with the same polarity. Resistors R1, R3, R5, R7, R9 are connected to the terminal of the AC source at one terminal, and connected respectively with the negative terminal of diode VD1, the positive terminal of rectifying diode VD3, the negative terminal of diode VD5, the positive terminal of rectifying diode VD7 and the negative terminal of diode VD9 at another terminal; resistor R2, R4 R6, R8, R10 are connected to the other terminal of the AC source at one end, and connected respectively with the negative terminal of diode VD2, the positive terminal of rectifying diode VD4, the negative terminal of diode VD6, the positive terminal of rectifying diode VD8 and the negative terminal of diode VD10 at another end; the positive terminal of diodes VD1, VD2 are connected respectively to the negative terminal of the LED D1, and the negative terminal of rectifying diodes VD3, VD4 are connected respectively to the positive terminal of the LED Dn and the positive terminal of the LED Dn+1; the positive terminal of diodes VD5, VD6 are connected respectively to the negative terminal of the LED Dm and the negative terminal of the LED Dm+1, the negative terminal of rectifying diodes VD7, VD8 are connected respectively to the positive terminal of the LED Dx and the positive terminal of the LED Dx+1; the positive terminal of diodes VD9, VD10 are connected to the negative terminal of the LED Dy. The terminals of the AC source are connected respectively to the two input terminals of the electric socket.

As shown in FIG. 11, when power is on, the AC output is positive at terminal a and negative at terminal b during first positive half cycle. At this time, only rectifying diode VD3, diode VD2, diode VD6, rectifier VD7 and diode VD10 are conducting; current flowing from the terminal a has passed through resistor R3, rectifying diode VD3, LEDs D1-Dn, diode VD2, resistor R2 and formed a loop with terminal b thereof, giving LEDs D1-Dn a half-wave rectifying voltage. Simultaneously, current flowing from the terminal a has also passed through resistor R3, rectifying diode VD3, LEDs Dn+1-Dm, diode VD6, resistor R6 and formed a loop with terminal b thereof, giving LEDs Dn+1-Dm a half-wave rectified voltage; at the same time, current flowing from the terminal a has also passed through resistor R7, rectifying diode VD7, LEDs Dm+1-Dx, diode VD6, resistor R6 and formed a loop with terminal b thereof, giving LEDs Dm+1-Dx a half-wave rectifying voltage; this current flowing from the terminal a again has passed through resistor R7, rectifying diode VD7, LEDs Dx+1-Dy, diode VD10, resistor R10 and formed a loop with terminal b thereof, giving LEDs Dx+1-Dy a half-wave rectifying voltage. During the next half cycle, the AC polarity reverses. AC output is negative at terminal a and positive at terminal b. Now, only rectifying diode VD4, diode VD1, diode VD5, rectifying diode VD8 and diode VD9 carry current while rectifying diode VD3, diode VD2, diode VD6, rectifying diode VD7 and diode VD10 formerly carrying current during the last half-cycle sit idle. Current flowing from terminal b has passed through resistor R4, rectifying diode VD4, LEDs D1-Dn, diode VD1, resistor R1 and formed a loop with terminal a thereof, giving LEDs D1-Dn another half-wave rectifying voltage; simultaneously, current flowing from terminal b has also passed through resistor R4, rectifying diode VD4, LEDs Dn+1-Dm, diode VD5, resistor R5 and formed a loop with terminal a thereof, giving LEDs Dn+1-Dm another half-wave rectifying voltage. At the same time, current flowing from terminal b has also passed through resistor R8, rectifying diode VD8, LEDs Dm+1-Dx, diode VD5, resistor R5 and formed a loop with terminal a thereof, giving LEDs Dm+1-Dx another half-wave rectifying voltage; simultaneously, current flowing from terminal b has also passed through resistor R8, rectifying diode VD8, LEDs Dx+1-Dy, diode VD9, resistor R9 and formed a loop with terminal a thereof, giving LEDs Dx+1-Dy another half-wave rectifying voltage. Repetition of such process in the circuitry provides the series blocks 1, 2,3, 4, each with a double half-wave rectifying voltage.

The embodiments described above do not mean to limit the scope of the present invention. For example, there can be a plurality of LED blocks and each LED block can include a plurality of LEDs.

What is claimed is:

1. A light string comprising a bridge rectifier circuit of four rectifying diodes connected in a bridge arrangement and a LED series block coupled upon the output loop of said bridge rectifier circuit, wherein said bridge rectifier circuit and said LED series block are at least two in number; a bridge rectifier circuit being formed combing the two rectifying diodes of the next bridge rectifier circuit having a connection at the negative polarity or the two rectifying diodes of the next bridge rectifier circuit having a connection at the positive polarity, with the two rectifying diodes of the last bridge rectifier circuit having a connection at the positive polarity or the two rectifying diodes of the last bridge rectifier circuit having a connection at the negative polarity; the series block of the two adjacent said bridge rectifier circuits being coupled with the LEDs of opposite polarity.

2. The light string as claimed in claim 1, in which the bridge rectifier circuit next to the AC source having two rectifying diodes interlinked at the positive terminal; the two rectifying diodes of said bridge rectifier circuit having a connection at the negative polarity associated with the two rectifying diodes of the next bridge rectifier circuit having a connection at the positive polarity formed a bridge rectifier circuit.

3. The light string as claimed in claim 1, in which the bridge rectifier circuit next to the AC source having two rectifying diodes interlinked at the negative terminal; the two rectifying diodes of said bridge rectifier circuit having a connection at the negative polarity associated with the two rectifying diodes of the next bridge rectifier circuit having a connection at the positive polarity formed a bridge rectifier circuit.

4. The light string as claimed in claim 1, wherein the two output terminals of the AC source are connected to an electrical outlet through the attached wire, respectively.

5. The light string as claimed in claim 1, wherein said electrical outlet refers to the electric socket.

6. The light string as claimed in either claim 1, or claim 2 or claim 3, in where a resistor is coupled at the two end of each of said LED series blocks, respectively.

7. An improved LED light string comprising at least one set of double half-wave rectification circuit and at least one LED series block with its positive terminal connecting to the terminals of said double half-wave rectification circuit; an impedance device being coupled intermediate the positive terminal of each of the rectifying diodes in said double half-wave rectification circuit and the AC source; and a pair of diodes with the same polarity being coupled intermediate the negative terminal of each of said LED series block(s) and the AC source terminals.

8. The improved LED light string as claimed in claim 7, wherein each of said double half-wave rectification circuit is connected with one said series block at the corresponding output terminals.

9. The improved LED light string as claimed in claim 7, wherein each of said double half-wave rectification circuit is connected with a pair of said series blocks at the corresponding output terminals.

10. The improved LED light string as claimed in claim 8 or 9, wherein the positive terminal of each of said diodes is connected respectively to the negative terminal of each of said LED series block(s), whereas the negative terminal of each of said diodes is connected to the terminals of the AC source through a respective resistor.

11. The improved LED light string as claimed in claim 8, when a plurality of said double half-wave rectification circuits are connected, the negative terminal of the LED series block in the next two sets of double half-wave rectification circuit is connected with the negative terminal of the LED series block in the last two sets of double half wave rectification circuit, and the two diodes of the same polarity is connected intermediate the negative terminal of another set of LED series block in said next two sets of double half-wave rectification circuit and the terminals of the AC source.

12. The improved LED light string as claimed in claim 7, wherein the output terminals of said AC source is connected to an electrical outlet through the attached lead wire.

13. The improved LED light string as claimed in claim 7, wherein said electrical outlet refers to the electric socket.
